(19) United States
(12) Patent Application Publication
(10) Pub. No.: US 2010/0232963 A1
(43) Pub. Date: Sep. 16, 2010

(54) STRUCTURAL MONITORING

(75) Inventors: Mark Volanthen, Southampton (GB); Nicholas John Harper, Southampton (GB); Richard Damon Goodman Roberts, Southampton (GB); Andrew Munro Gallon, Southampton (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Insensys Limited

(21) Appl. No.: 12/377,950

(22) PCT Filed: Aug. 20, 2007
(86) PCT No.: PCT/GB07/03180

§ 371 Date: Apr. 21, 2010

(30) Foreign Application Priority Data
Aug. 18, 2006 (GB) 0616506.2

(51) Int. Cl. F03D 9/00; G01B 11/16; G01K 13/00; B21D 53/78

(52) U.S. Cl. 416/146 R; 356/32; 374/142; 29/889; 374/E13.001

(57) ABSTRACT

A load monitoring system for wind turbine blades utilizes optical fibre strain sensors (5) moulded into the turbine blades. A sensor monitoring instrument is located in the hub (3) of the turbine. Various arrangements of cabling are disclosed to maximize fault tolerance. Various arrangements of a temperature compensation device for the strain sensors is also disclosed. The strain sensors (5) and optical fibre (7) may be provided on a pre-cured patch (9) for incorporation in the structure of the turbine blade. Furthermore, it is disclosed that each blade comprises an optical fibre strain sensor and a cable to connect the sensors to processing equipment, wherein each such cable includes a connector at each end whereby each blade can be replaced independently. Also, it is shown to provide an output connector for connecting the sensor to processing equipment in a cavity that is filled with a material for inhibiting free movement of the output connector.

### FIELD OF THE INVENTION

This invention relates to the structural monitoring of wind turbine blades and, in particular, to the structural monitoring of wind turbine blades using fibre optic strain sensors.

### BACKGROUND TO THE INVENTION

Blades for wind turbines are typically constructed of glass-reinforced plastics (GRP) on a sub-structure, which may be formed of wood, glass fibre, carbon fibre, foam or other materials. Graphite fibre in epoxy resin is also used. The plastics resin can be injected into a mould containing the sub-structure to form the outer surface of the blade. The blade may also be built up as a series of layers of fibre material and resin. In some cases, the fibre material is pre-impregnated with resin.

A typical wind turbine blade may have a length of between 20 and 60 metres or more. As the interior of the blade is generally hollow, a “floor” is provided within the blade proximate the hub-engaging end of the blade. The blade floor is a bulkhead about 0.5 metres to 2.5 metres into the blade that prevents service personnel falling into a blade while working in the hub.

It is known, for example from U.S. Pat. No. 4,297,076, to provides the blades of a wind turbine with strain gauges and to adjust the pitch of portions of the blades in response to the bending moment on the blades measured by the strain gauges. Optical fibre strain sensors are known and WO 2004/056017 discloses a method of interrogating multiple fibre Bragg grating strain sensors along a single fibre. In the system of WO 2004/056017, Bragg gratings are defined in the optical fibre at spaced locations along the optical fibre. When the optical fibre is put under strain, the relative spacing of the planes of each Bragg grating changes and thus the resonant optical wavelength of the grating changes. By determining the resonant wavelength of each grating, a strain measurement can be derived for the location of each grating along the fibre. Optical strain sensors operating on the principle of back scattering which do not require discrete grating along the fibre are also known.

This application discloses methods and means for optimizing the incorporation of optical fibre strain sensors into wind turbine blades.

### SUMMARY OF THE INVENTION

According to an invention disclosed herein, there is provided a blade for a wind turbine formed from at least two blade sections. The blade comprises a first strain sensor located in a first blade section and a second strain sensor located in a second blade section. The first strain sensor is connected to an output connection via a first cable and the second strain sensor is connected to the first strain sensor via a second cable, whereby the second strain sensor is connected to the output connection via the first cable.

Thus, according to the arrangement described above, the strain sensors in the blade sections are connected to each other by the second cable, which can be significantly shorter than the first cable which connects the first strain sensor to the output connection, typically at the hub end of the blade.

The strain sensors according to the invention(s) disclosed herein may be strain gauges, extensometers or other electrical strain sensors. In the preferred arrangements, the strain sensors are optical strain sensors. For example, the strain sensors may be optical fibre strain sensors, such as Bragg fibre grating sensors. The fibre Bragg grating sensors may also be used as temperature sensors.

Similarly, the cables may be electrical cables. Where the strain sensors are optical strain sensors, the cables preferably comprise optical fibres. This has the advantage that it is unnecessary to locate electronics within the blades. It is possible for the first strain sensor, second strain sensor, first cable and/or second cable to form one or more integral single optical fibres. In other words, the first strain sensor, second strain sensor, first cable and second cable (or any sub-combination) may be provided by a single optical fibre. Alternatively, permanent or non-permanent connectors may be provided between the strain sensors and cables.

Typically, the blade sections will be blade halves. However, the blades may be formed from more than two blade sections. It is not necessary for the blade sections to be identical or even similar in size or configuration. However, each blade section typically forms a substantial part of the structure of the blade. In general, each blade section may comprise a substantial part of the outer surface of the turbine blade. The blades sections need not form part of the outer surface of the blades, provided that strain on the blades sections is representative of strain on the whole blade. Thus, the blade sections might be shear webs or the bulk structure of the blade.

The strain sensors may be located on the inside of the blade sections. The strain sensors may be applied to the blade sections before or after the blade sections are assembled into the blade.

The first cable may be located within the first blade section. The second cable may be located between the first and second blade section in the final blade.

In general, the output connection is configured for connection to signal processing equipment. The signal processing equipment will process signals from the strain sensors to derive an indication of strain in the turbine blade. In one arrangement, each blade has a respective output connection. Alternatively, the blades may be connected to a common output connection, for example as a daisy chain.

According to an invention disclosed herein, there is provided a temperature sensitive device for an optical strain sensor, the device comprising a conduit surrounding an optical fibre and fixed to the optical fibre at each end of the conduit, wherein the length of the optical fibre within the conduit is greater than the distance between the ends of the conduit.

In this arrangement, the optical fibre can be sealed to the conduit and the conduit can therefore be included within the resin of a turbine blade, for example. However, the optical fibre is decoupled from the strain on the conduit, because the optical fibre is longer than the distance between the ends of the conduit. The distance between the ends of the conduit is measured as a straight line, whereas the length of the optical fibre is the actual length of the fibre.

The ends of the conduit are defined by the points at which the optical fibre is fixed to the conduit. In general, the optical fibre is arranged so that it does not overlap itself within the conduit. Thus, there are generally no loops of the optical fibre within the conduit. This allows the conduit to be relatively narrow in order not to take up too much lateral space.

The conduit may be substantially linear, i.e. the conduit may substantially longer than it is wide. The conduit may include at least one arcuate portion. In this case, the curvature of the conduit ensures that the (straight line) distance between the ends is greater than the length of optical fibre between the ends of the conduit. The conduit may comprise a plurality of arcuate portions. For example, the conduit may have an undulating form.

The conduit may include a plurality of arcuate portions, whereby the portions of the optical fibre exiting each end of the conduit are parallel, in particular collinear. In this way, the temperature compensation device does not affect the direction of the optical fibre.

The conduit may be in the form of a tube. The cross-section of the conduit may be any suitable shape. In general the cross-section of the conduit is substantially circular. It is not necessary for the cross-sectional area of the conduit to be constant along its length.

The temperature sensitive device may take the form of a temperature compensation device for an optical strain sensor.

The conduit is formed from a base and a cover, whereby the optical fibre can be located within the conduit during manufacture by placing the optical fibre on the base and attaching the cover. This significantly simplifies manufacture of the device, because it is not necessary to thread the optical fibre through the conduit. The portion of the optical fibre within the conduit may comprise an optical fibre strain sensor (decoupled from the strain applied to the conduit).

According to an invention disclosed herein, there is provided a method of constructing a wind turbine blade including at least one strain sensor, the method comprising the step of applying to the blade structure a pre-formed component comprising at least one optical fibre strain sensor having an output connection and mounted to a substrate.

According to this arrangement, it is possible to provide a pre-tested, pre-formed component which can be fitted to the blade structure during manufacture of the blade. This significantly simplifies inclusion of a strain sensor, particularly an optical strain sensor, in the turbine blade.

The optical fibre strain sensor may be located on the substrate in a predetermined position and the component may include at least one location aid to enable the component to be located correctly relative to the wind turbine blade, whereby the optical fibre strain sensor is located correctly relative to the blade. The location aid may comprise markings, holes, edges, surfaces, projections, indentations or the like, which assist in locating the optical strain sensor relative to the turbine blade.

The step of fixing the component relative to the blade structure may be included in the method prior to the structure being infused with resin or prior to the resin being cured. In this way, the optical fibre strain sensor can be accurately placed prior to cure and form an integral part of the turbine blade. As an alternative to infusing dry fibre with resin, the blade may be formed of layers of resin impregnated or pre-impregnated fibre material.

According to an invention disclosed herein, there is provided a pre-formed component comprising at least one optical fibre strain sensor having an output connection and mounted to a substrate, the component being adapted for use in the method described above.

The substrate may be any suitable material, such as a glass fibre resin laminate.

According to an invention disclosed herein, there is provided a wind turbine comprising a plurality of blades, each comprising at least one optical fibre strain sensor and at least one respective cable for each blade to connect the strain sensors to signal processing equipment, wherein each such cable includes a connector at each end whereby each cable can be replaced independently.

According to an invention disclosed herein, there is provided a blade for a wind turbine comprising at least one optical fibre strain sensor and at least one output connector for connecting the strain sensor to signal processing equipment, wherein the output connector is located in a connection cavity and the connection cavity is filled with a material for inhibiting free movement of the output connector as the blade rotates.

### BRIEF DESCRIPTION OF THE DRAWINGS

Embodiments of the invention will now be described by way of example only and with reference to the accompanying drawings, in which:

FIGS. 1 to 3 are schematic representations of cable connections between strain sensors and the hub of a wind turbine;

FIGS. 4 to 10 are schematic representations of temperature compensation devices for use so in a turbine blade load monitoring system;

FIGS. 11 to 13 are schematic representations of preformed sensor devices for use in a turbine blade load monitoring system; and

FIG. 14 is a schematic representation of a further temperature compensation device for use in a turbine blade load monitoring system.

### DETAILED DESCRIPTION OF EMBODIMENTS

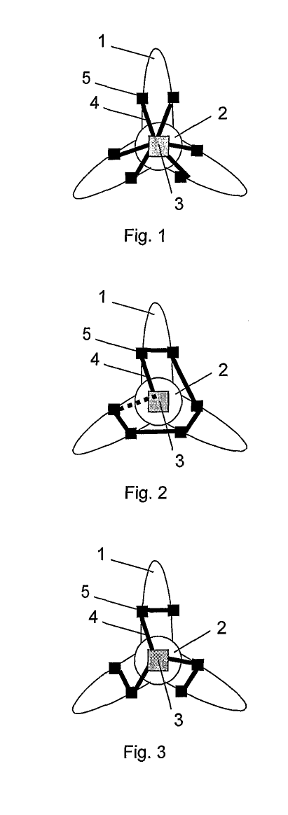

FIGS. 1 to 3 show schematically the arrangement of the cables in a wind turbine having two optical fibre strain sensors 5 in each blade 1. The blades 1, each connect to a hub 2 which includes the signal processing electronics (instrument) 3 which receives signals from the strain sensors 5 in the blades 1. A suitable method of interrogating multiple fibre Bragg grating strain sensors along a single fibre is described in WO 2004/056017.

In many cases, the outer surfaces of wind turbine blades are made in two halves, which are then assembled together with other structural parts, such as shear webs, box beams and the like to form the blade 1. It is desirable to locate load sensors 5 in both halves of the blade to achieve the most effective monitoring. Furthermore, it is preferable to install the sensors 5 during the manufacturing of each blade half, for reasons of efficient manufacture.

As shown in FIGS. 1 to 3, a number of configurations are possible to connect sensors 5 in both halves of all three blades back to the instrument 3 located in the hub 2. One scheme is to have six cables 4 leading directly from the instrument 3 to each blade half, as shown in FIG. 1. In this case, if a single fibre (cable) breaks, only one blade 1 is affected, which makes this arrangement relative fault tolerant. However, to achieve this, the arrangement of FIG. 1 requires six long cables 4, which is a disadvantage in terms of the cost of materials and the risk of breakages.

A second scheme, shown in FIG. 2, is to daisy-chain together the sensors 5 from all the blade halves 1. This again requires six long cables 4 and also means that a single break in any cable will lose signals from all sensors 5 beyond the break in the daisy chain. This is a significant disadvantage in terms of fault tolerance. As shown in FIG. 2, if a seventh cable 4 (shown in dotted lines) is added, the system becomes tolerant to a single break, because the strain sensors 5 can be interrogated from either end of the daisy chain.

FIG. 3 shows an arrangement according to an invention disclosed herein. According to this arrangement, a short optical fibre jumper cable 4a connects each blade half together. The jumper cables 4a can be fitted in the factory, either as the blade halves are moulded or as they are assembled. This arrangement provides an optimum trade-off between the length of the required cable and the tolerance to breakage of fibres, because only three long cables 4 are required in the hub 2 (one to each blade), but a single fibre break will at most affect only one blade 1.

For blades that are made in more than two pieces, for example with a join part way along the length of the blade, where sensors 5 are required in more than one section of the blade 1, optical jumpers 4a can be used to connect the sensors 5, in the manner described above.

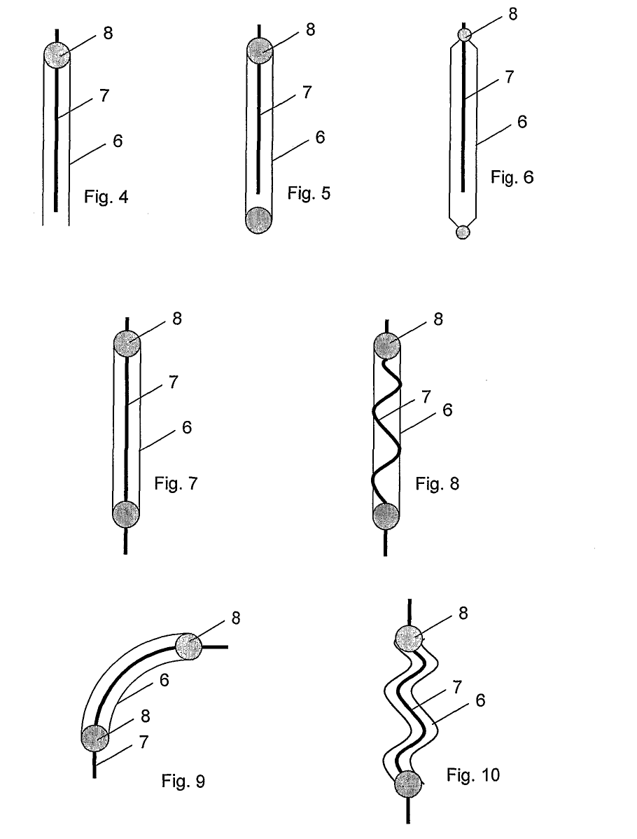

FIGS. 4 to 9 illustrate a temperature compensation scheme according to an invention disclosed herein. Optical fibre strain sensors respond to both strain and temperature, because the optical fibre is subject to thermal expansion and the refractive index of the glass changes with thermal changes of density. To remove the effect of temperature on a strain sensor it is known to use a sensor isolated from the strain of the structure being measured to detect the effect of temperature alone and to compensate the strain measurement on the basis of the reading from the unstrained sensor. One method, illustrated in FIG. 4, is to place the last of an array of optical strain sensors in a capillary tube 6 and to glue the fibre 7 at one end and terminate the fibre within the tube. In this way, the optical strain sensor is isolated from strain by the capillary tube 6 and registers only changes due to thermal expansion.

The use of an arrangement as shown in FIG. 4 imposes significant restrictions on the positioning of the complete fibre optic strain sensing device, because the temperature compensating sensor must be the final sensor on the fibre. In some circumstances, the location of the temperature compensating sensor at the end of the fibre may be incompatible with the desired location of the temperature compensating sensor on the turbine blade. For example, it may be desired to located the temperature compensating sensor centrally on a turbine blade in order that the turbine blade acts as a heat sink to inhibit local fluctuation of the temperature measurement which may hinder accurate temperature compensation. Similarly, it may be desirable to locate the temperature compensating sensor within the bulk material of the turbine blade, whereas it may be desirable to locate the strain sensors at the surface of the blade.

There is disclosed herein a temperature compensation concept that can be used for sensors contained within a composite material and/or where the fibre can not be terminated within the tube as it is required as a signal path to another sensor or a connector. For the temperature compensating sensor to be embedded within a composite material the tube (or any other shape enclosure) should be sealed at both ends to prevent resin ingress, as shown in FIG. 5. An improvement to reduce the chance of resin ingress is to reduce the size of the opening of the isolation region, for example by tapering a tube, or producing a small hole in a larger enclosure, as shown schematically in FIG. 6. However, when the fibre path must extend through the temperature compensating sensor (strain isolation device), the scheme in FIG. 7 is not appropriate strain on the capillary tube 6 is transferred to the fibre 7, as the fibre is bonded to the capillary tube by the resin seals 8.

One method of allowing the enclosure (capillary tube 6) to experience strain without transferring the strain to the fibre is to “over-stuff' the enclosure, as shown in FIG. 8. In this case, the length of the fibre 7 between the resin seals 8 is greater than the direct distance between the resin seals 8. In this way, even if the capillary tube 6 is put under strain, the strain will not be transferred to the fibre 7, because there is sufficient slack in the fibre 7 between the points (resin seals 8) at which it is connected to the capillary tube 6.

A further alternative, shown in FIG. 9, is to use a curved section of fibre located in the middle of an enclosure. This may take the form of a bent tube 6. As the tube 6 moves due to strain, the strain will not be transferred to the fibre 7 all the time if is not in contact with the walls of the tube 6. In effect, the curvature of the tube 6 provides slack between the resin seals 8 so that the fibre 7 is not put under strain.

A series of bends may be made in the isolation space, as shown in FIG. 10, such that the capillary tube 6 adopts an undulating shape. An advantage of this arrangement is that the fibre can exit the isolation device (capillary tube 6) in the same direction as it enters the device. Combinations of “over-stuffing” and bends may also be used to extend the range of isolation.

In wind turbines, the isolation region may also be a connector box in the blade, which provides a pre-existing air space ideal for locating a temperature compensation sensor.

The space in the isolation region does not need to be filled with air (or other gas) and could contain a gel or other non-strain transferring material.

The integration of optical fibre sensors within wind turbine blades during blade production with minimal impact to the manufacturing process presents a number of engineering challenges. The location of the optical fibre sensors on the turbine blades is important in the accurate characterization of the mechanical behaviour of the blade in use and the optical fibres are relatively fragile compared to the bulk material of the blade. Different blades are made in different ways and from different materials. An invention disclosed herein provides a simple, rapid method of locating sensors and connectors in a blade at desired locations.

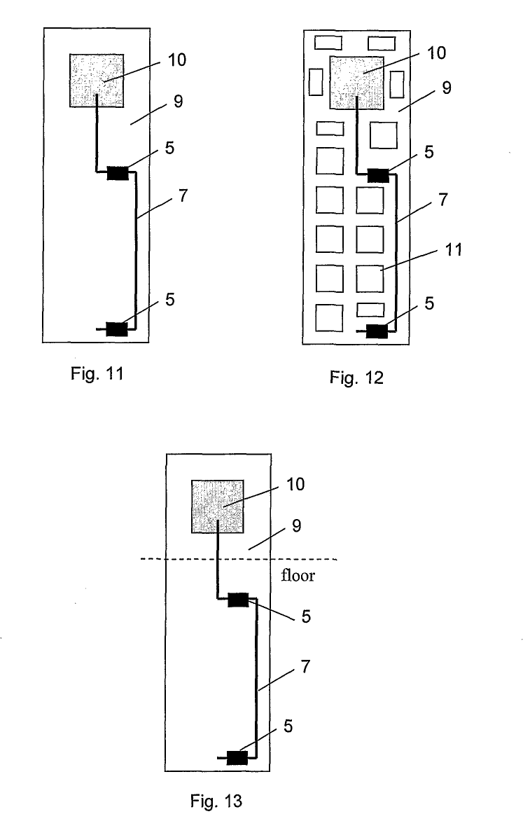

As shown in FIG. 11, a pre-cured composite patch of material includes embedded optical fibre sensors 5 located at the required positions and a connector box 10. The patch may be made of any suitable material such as wood or plastics. The pre-cured patch 9 has a degree of stiffness and provides protection to the fibre 7 which means it can be handled without special care. This assists in the ease and speed of incorporation of the optical fibre sensor 5 in the turbine blade. The stiffness of the patch 9 prevents the fibre 7 kinking or bending too tightly and breaking. Furthermore, the patch 9 forms a single, functioning unit that can be tested prior to leaving the factory. The patch 9 can be located onto the blade using a jig or alignment markings and fixed to the turbine blade using two or more staples or similar attachment means. Locations to apply fixings can be clearly marked on the patch 9. In this simple alignment and temporary fixing step, all of the sensors 5 have been located at their desired positions. The patch 9 is held permanently in place when the resin is cured. As shown in FIG. 12, to improve resin flow around the patch 9, the patch 9 may include holes 11 through the cured laminate to allow the resin to pass more freely and to hold the patch 9 in position in the final blade.

The patch 9 may include one or more temperature compensation devices in addition to strain sensors. These may be located in the connector box 10 or elsewhere on the cured patch 9. The connector box 10 is located a sufficient distance from all strain sensors 5 to ensure it does not affect the measurement and make the blade locally stiffer.

The connector box 10 may be located on the hub side of the blade floor (for easier connection) while the sensors 5 are located on the blade side of the floor (optimal positions), as indicated by the dashed line in FIG. 13. This removes any need to run cables through the blade floor.

It has been found that the most likely failure mode of the turbine blade load measurement system is due to damage to the cable connecting each blade with the instrument in the hub or the next blade if daisy-chained, for example the long cables 4 of FIGS. 1 to 3. However, such cables are generally provided as a permanent connection between the instrument and the connector boxes, which makes the replacement of these cables a time consuming and skilled task. The provision of a permanent connection is presumably the result of concern that vibration in the blade or hub could result in the disconnection of a non-permanent connection. However, the inventors have realized that with the strain sensors in position, the blades can be balanced to minimize vibration. Consequently, the provision of a removable cable between the instrument and the connector boxes in the blades is feasible and has the significant operational advantage that the replacement of a malfunctioning cable can be achieved very quickly. By making such cables fully replaceable, having connectors on both ends, they may be easily replaced. This also makes it possible for a blade to be replaced, or the instrument itself to be replaced. Thus, in the system described herein, a connector is provided both at the blade and the hub end of the cable.

Moreover, the constant spinning motion of a wind turbines induces cycling gravitational forces on all the components in the blade and hub. Optical fibres deployed within the blade are fully supported by the resin and glass structure of the blade. However, fibres in the connector box 10 (and even in the temperature compensation sensor) are unsupported and can move about in the available space. Constant movement of unsupported optical fibres may lead to failure by crack fatigue propagation, abrasion or other methods. A solution to this problem disclosed herein is to restrict the movement of the optical fibre in certain cavities of the load measurement system by filling or selectively applying a material to key components. Components include connector boxes, connecting cables, temperature compensation devices and the measurement instrument itself. Thus, such components may be located (potted) in a material of higher effective viscosity than air in order to hinder movement of the components within the cavity. Such a step improves the fatigue performance of the fibres and components. A suitable material may be a liquid, such as oil, a gel or a solid material, such as a potting compound. Other possibilities include a particulate material such as expanded polystyrene to pack the components in position. Ideally, the material is removable to enable maintenance.

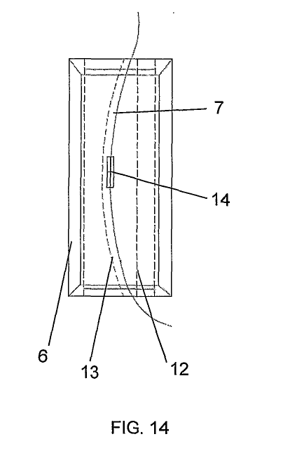

FIG. 14 shows a temperature sensor in the form of a fibre Bragg grating 14, which is located in a housing 6. The housing 6 defines a conduit for the fibre 7 that has one straight wall 12 and one curved wall 13. In the region of the temperature sensor 14, the optical fibre 7 is arranged between the walls 12, 13 in an arc that follows, but is spaced from the curved wall 13. The housing 11 has a lid which closes the upper surface of the conduit once the optical fibre 7 has been located within the conduit. The portion of the optical fibre 7 within the conduit is free to expand or contract thermally with changes in temperature as it is mechanically isolated from the surface on which the sensor is mounted by the housing 11. Once the optical fibre 7 is located within the conduit, the fibre 7 can be maintained in position by resin seals (not shown) at either end of the conduit.

The various features that have been described in this application may be used in any suitable combination.

In summary, a load monitoring system for wind turbine blades utilizes optical fibre strain sensors 5 moulded into the turbine blades. A sensor monitoring instrument is located in the hub 3 of the turbine. Various arrangements of cabling are disclosed to maximize fault tolerance. A temperature compensation device for the strain sensors is also disclosed. The strain sensors 5 and optical fibre 7 may be provided on a pre-cured patch 9 for incorporation in the structure of the turbine blade.

1. A blade for a wind turbine formed from at least two blade sections, the blade comprising a first strain sensor located in a first blade section and a second strain sensor located in a second blade section, wherein the first strain sensor is connected to an output connection via a first cable and the second strain sensor is connected to the first strain sensor via a second cable, whereby the second strain sensor is connected to the output connection via the first cable.

2. A blade as claimed in claim 1, wherein the strain sensors are optical strain sensors and the cables comprise optical fibres.

3. A blade as claimed in claim 1, wherein the first cable is located within the first blade section.

4. A wind turbine comprising a plurality of blades as claimed in claim 1, wherein each blade has a respective output connection.

5. A temperature sensitive device for an optical strain sensor, the device comprising a conduit surrounding an optical fibre and fixed to the optical fibre at each end of the conduit, wherein the length of the optical fibre within the conduit is greater than the distance between the ends of the conduit.

6. A temperature sensitive device as claimed in claim 5, wherein the conduit is substantially linear.

7. A temperature sensitive device as claimed in claim 5, wherein the conduit includes at least one arcuate portion.

8. A temperature sensitive device as claimed in claim 7, wherein the conduit includes a plurality of arcuate portions, whereby the portions of the optical fibre exiting each end of the conduit are parallel, in particular collinear.

9. A temperature sensitive device as claimed in claim 1, wherein the conduit is formed from a base and a cover, whereby the optical fibre can be located within the conduit during manufacture by placing the optical fibre on the base and attaching the cover.

10. An optical fibre strain sensor array as claimed in claim 1, wherein the portion of the optical fibre within the conduit comprises an optical fibre strain sensor.

11. A method of constructing a wind turbine blade including at least one strain sensor, the method comprising the step of applying to the blade structure a pre-formed component comprising at least one optical fibre strain sensor having an output connection and mounted to a substrate.

12. A method as claimed in claim 11, wherein the optical fibre strain sensor is located on the substrate in a predetermined position and the component includes at least one location aid to enable the component to be located correctly relative to the wind turbine blade, whereby the optical fibre strain sensor is located correctly relative to the blade.

13. A method as claimed in claim 11 further comprising the step of fixing the component relative to the blade structure prior to the structure being infused with resin.

14. A pre-formed component comprising at least one optical fibre strain sensor having an output connection and mounted to a substrate, the component being adapted for use in the method of claim 11.

15. A wind turbine comprising a plurality of blades, each comprising at least one optical fibre strain sensor and at least one respective cable for each blade to connect the strain sensors to signal processing equipment, wherein each such cable includes a connector at each end whereby each cable can be replaced independently.

16. A blade for a wind turbine comprising at least one optical fibre strain sensor and at least one output connector for connecting the strain sensor to signal processing equipment, wherein the output connector is located in a connection cavity and the connection cavity is filled with a material for inhibiting free movement of the output connector as the blade rotates.
